(19) United States
(12) Patent Application Publication
(10) Pub. No.: US 2003/0076831 A1
(43) Pub. Date: Apr. 24, 2003

(54) Mechanism for packet component merging and channel assignment, and packet decomposition and channel reassignment in a multiprocessor system

(76) Inventors: Stephen R. Van Doren, Northborough, MA (US); Simon C. Steely JR., Hudson, NH (US); Madhumitra Sharma, Shrewsbury, MA (US)

Correspondence Address: CESARI AND MCKENNA, LLP, 88 BLACK FALCON AVENUE, BOSTON, MA, 02210, US

(21) Appl. No.: 09/813,579

(22) Filed: Mar. 21, 2001

Related U.S. Application Data
(60) Provisional application No. 60/208,160, filed on May 31, 2000.

(51) Int. Cl. H04L 12/28

(52) U.S. Cl. 370/394; 370/412

(57) ABSTRACT

A technique efficiently combines data and ordered transactions in a multiprocessor system having a plurality of nodes interconnected by a hierarchical switch. The technique further enables an ordered channel of the system to make progress in the presence of a blocked interface within the hierarchical switch. Specifically, the technique combines ordered components and unordered data components into common packets that are transmitted over an ordered channel of the system in the event that ordered and unordered components are generated simultaneously. The technique further allows, in the event that a combined packet in the ordered channel is stalled due to a data buffer dependency, the packet to be decomposed into an ordered component and an unordered data component wherein the ordered component remains in the ordered channel and the unordered data component is reassigned to the unordered data channel.

### CROSS-REFERENCE TO RELATED APPLICATIONS

The present application claims priority from U.S. provisional patent application Ser. No. 60/208,160, which was filed on May 31, 2000, by Stephen Van Doren, Simon Steely and Madhumitra Sharma for a MECHANISM FOR PACKET COMPONENT MERGING AND CHANNEL ASSIGNMENT, AND PACKET DECOMPOSITION AND CHANNEL REASSIGNMENT IN A MULTIPROCESSOR SYSTEM and is hereby incorporated by reference.

### BACKGROUND OF THE INVENTION

1. Field of the Invention The present invention relates generally to distributed shared memory multiprocessor systems and, in particular, to distributed shared memory multiprocessor systems that route transactions through a system interconnect over discrete virtual channels, while maintaining balance between bandwidth consumption and channel progress.

2. Background Information

In a distributed shared memory multiprocessor system, transactions that are issued to the system and responses that result from those transactions are typically routed through the system by way of packet “channels”. A channel comprises an independently buffered and flow-controlled interconnect path through the system. The channel may be “discrete” in that it shares no buffering, interconnect or flow control elements with any other channel. Alternatively, the channel may be “virtual” in that it shares one or more of the buffering, interconnect or flow control elements, yet operates such that a stoppage in progress does not halt progress in some or all of the other channels. The multiprocessor system generally assigns transactions to these channels according to a transaction type. For example, input/output (I/O) space references and memory space references are assigned to their own channels. Responses to the I/O and memory space references have two basic components: an ordered component and an unordered data only component. Each of these components is assigned to its own channel.

For memory space commands, the ordered response component is generated upon issuance of the command to memory. If the command requires a data response packet and the most up-to-date copy of the requested data resides in memory, then the unordered data component of the response is generated at the same time as the ordered component. If the most up-to-date copy of the data is stored in a cache of a processor, then the data component is generated when the data is fetched from that cache. For I/O commands, the order and data components are typically generated together. Most traffic in a computer system tends to be memory space traffic and further tends to be such that the most up-to-date copy of data in the system is in the memory. Thus, most traffic in the system generates both ordered and unordered response packets at the system's memory. Returning both the ordered and unordered packets to the source processor independently results in substantial duplication and, accordingly, wasted system bandwidth.

All transactions issued to the system generate at least one ordered response packet. Many transactions result in the issuance of multiple ordered response packets with each packet targeting a different processor or group of processors. Meanwhile, only a small percentage of commands generate unordered data response packets and, in typically all cases, generate at most one packet. Because such a high percentage of system traffic is of the ordered variety, system performance is heavily dependent upon the progress of this channel. In an effort to minimize the impact duplication has on bandwidth, the corresponding unordered and ordered response packets may be combined into a single packet when a memory reference locates its data in memory. In this case, progress of the ordered channel and thus performance of the system becomes dependent upon the ability of the unordered data channel to make progress.

Since data buffers consume substantial silicon “real estate”, it is desirable to minimize the amount of data buffering contained in application specific integrated circuits (ASICs) of a computer system. In general, only enough data buffering is included to support the maximum data bandwidth on each interface of the system's interconnect. If a particular interface begins to “backup” such that its associated data buffers become full, then additional data packets targeting that interface must be stalled. Stalling of only those data packets in the unordered data channel targeting a particular interface has minimal system-wide impact. Since the channel is unordered, packets that target other interfaces can bypass packets that target the stalled interface. This allows the majority of the system to make forward progress. If ordered components and unordered data components are combined in common packets in the ordered channel, then stalling data packets targeting a particular data interface can have significant system-wide performance implications. Since the channel is ordered, when a packet targeting the stalled interface is stalled, all packets behind it are stalled as well.

Prior attempts to balance the problem of bandwidth consumption with channel progress include combining data and ordered packets when possible and suffering as a result of ordered channel blocking. Additional attempts include routing data and ordered packets separately, while suffering the associated bandwidth loss. The present invention is directed to a technique that allows efficient balancing between bandwidth consumption and channel progress in a multiprocessor system.

### SUMMARY OF THE INVENTION

The present invention comprises a technique that efficiently combines data and ordered transactions in a multiprocessor system having a plurality of nodes interconnected by a hierarchical switch. The technique further enables an ordered channel of the system to make progress in the presence of a blocked interface within the hierarchical switch. Specifically, the inventive technique combines ordered components and unordered data components into common packets that are transmitted over an ordered channel of the system in the event the ordered and unordered components are generated simultaneously. In the event that a combined packet in the ordered channel is stalled due to a data buffer dependency, the technique further allows decomposition of the packet into an ordered component and an unordered data component. In this latter case, the ordered component remains in the ordered channel and the unordered data component is reassigned to the unordered data channel.

### BRIEF DESCRIPTION OF THE DRAWINGS

The above and further advantages of the invention may be better understood by referring to the following description in conjunction with the accompanying drawings, in which like reference numbers indicated identical or functionally similar elements:

FIG. 1 is a schematic block diagram of a modular, symmetric multiprocessing (SMP) system having a plurality of Quad Building Block (QBB) nodes interconnected by a hierarchical switch (HS);

FIG. 2 is a schematic block diagram of a QBB node coupled to the SMP system of FIG. 1;

FIG. 3 is a schematic block diagram of the HS of FIG. 1;

FIG. 4 is a schematic block diagram illustrating virtual channels of the SMP system that may be advantageously used with the present invention;

FIG. 5 is a schematic block diagram showing an arrangement between a processor and a local switch of a QBB node;

FIG. 6 is a schematic block diagram illustrating an arrangement between a home QBB node and a destination QBB node that may be advantageously used with the present invention; and

FIG. 7 is a schematic block diagram of decomposition logic that may be advantageously used with the present invention.

### DETAILED DESCRIPTION OF AN ILLUSTRATIVE

### EMBODIMENT

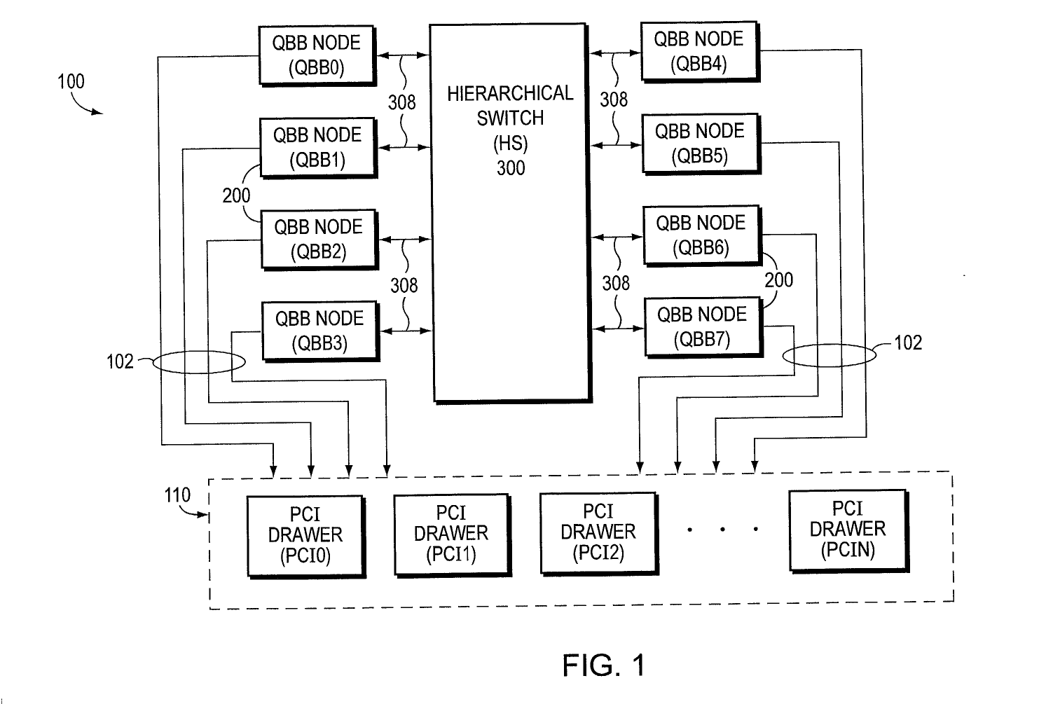

FIG. 1 is a schematic block diagram of a modular, symmetric multiprocessing (SMP) system 100 having a plurality of nodes interconnected by a hierarchical switch (HS) 300. The SMP system further includes an input/output (I/O) subsystem 110 comprising a plurality of I/O enclosures or “drawers” configured to accommodate a plurality of I/O buses that preferably operate according to the conventional Peripheral Computer Interconnect (PCI) protocol. The PCI drawers are connected to the nodes through a plurality of I/O interconnects or “hoses” 102.

In the illustrative embodiment described herein, each node is implemented as a Quad Building Block (QBB) node 200 comprising a plurality of processors, a plurality of memory modules, an I/O port (IOP) and a global port (GP) interconnected by a local switch. Each memory module may be shared among the processors of a node and, further, among the processors of other QBB nodes configured on the SMP system. A fully configured SMP system preferably comprises eight (8) QBB (QBB0-7) nodes, each of which is coupled to the HS 300 by a full-duplex, bi-directional, clock forwarded HS link 308.

Data is transferred between the QBB nodes of the system in the form of packets. In order to provide a distributed shared memory environment, each QBB node is configured with an address space and a directory for that address space. The address space is generally divided into memory address space and I/O address space. The processors and IOP of each QBB node utilize private caches to store data for memory-space addresses; I/O space data is generally not “cached” in the private caches.

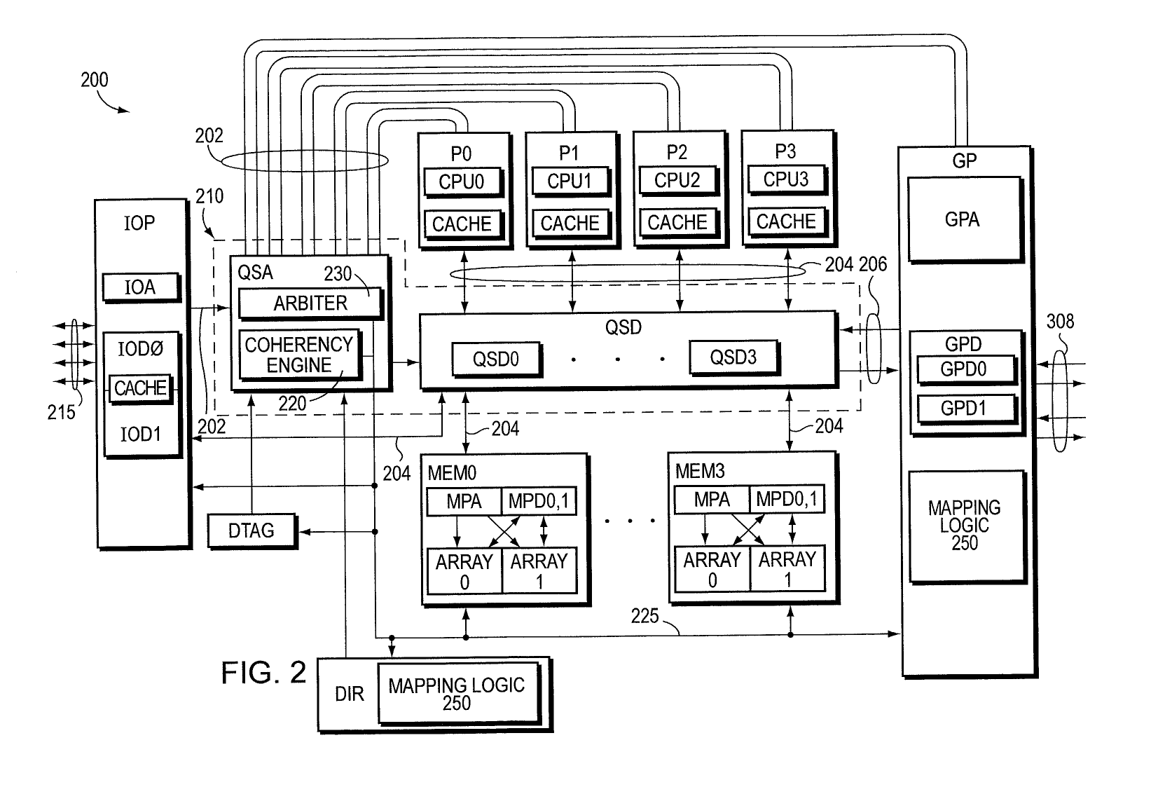

FIG. 2 is a schematic block diagram of a QBB node 200 comprising a plurality of processors (P0-P3) coupled to the IOP, the GP and a plurality of memory modules (MEM0-3) by a local switch 210. The memory may be organized as a single address space that is shared by the processors and apportioned into a number of blocks, each of which may include, e.g., 64 bytes of data. The IOP controls the transfer of data between external devices connected to the PCI drawers and the QBB node via the I/O hoses 102. As with the case of the SMP system, data is transferred among the components or “agents” of the QBB node in the form of packets. As used herein, the term “system” refers to all components of the QBB node excluding the processors and IOP.

Each processor is a modern processor comprising a central processing unit (CPU) that preferably incorporates a traditional reduced instruction set computer (RISC) load/store architecture. In the illustrative embodiment described herein, the CPUs are Alpha®21264 processor chips manufactured by Compaq Computer Corporation, Houston, Tex., although other types of processor chips may be advantageously used. The load/store instructions executed by the processors are issued to the system as memory references, e.g., read and write operations. Each operation may comprise a series of commands (or command packets) that are exchanged between the processors and the system.

In addition, each processor and IOP employs a private cache for storing data determined likely to be accessed in the future. The caches are preferably organized as write-back caches apportioned into, e.g., 64-byte cache lines accessible by the processors; it should be noted, however, that other cache organizations, such as write-through caches, may be used in connection with the principles of the invention. It should be further noted that memory reference operations issued by the processors are preferably directed to a 64-byte cache line granularity. Since the IOP and processors may update data in their private caches without updating shared memory, a cache coherence protocol is utilized to maintain data consistency among the caches.

The commands described herein are defined by the Alpha® memory system interface and be classified into three types: requests, probes, and responses. Requests are commands that are issued by a processor when, as a result of executing a load or store instruction, it must obtain a copy of data. Requests are also used to gain exclusive ownership to a data item (cache line) from the system. Requests include Read (Rd) commands, Read/Modify (RdMod) commands, Change-to-Dirty (CTD) commands, Victim commands, and Evict commands, the latter of which specify removal of a cache line from a respective cache.

Probes are commands issued by the system to one or more processors requesting data and/or cache tag status updates. Probes include Forwarded Read (Frd) commands, Forwarded Read Modify (FRdMod) commands and Invalidate (Inval) commands. When a processor P issues a request to the system, the system may issue one or more probes (via probe packets) to other processors. For example if P requests a copy of a cache line (a Rd request), the system sends a Frd probe to the owner processor (if any). If P requests exclusive ownership of a cache line (a CTD request), the system sends Inval probes to one or more processors having copies of the cache line.

Moreover, if P requests both a copy of the cache line as well as exclusive ownership of the cache line (a RdMod request) the system sends a FRdMod probe to a processor currently storing a “dirty” copy of a cache line of data. In this context, a dirty copy of a cache line represents the most up-to-date version of the corresponding cache line or data block. In response to the FRdMod probe, the dirty cache line is returned to the system and the dirty copy stored in the cache is invalidated. An Inval probe may be issued by the system to a processor storing a copy of the cache line in its cache when the cache line is to be updated by another processor.

Responses are commands from the system to processors and/or the IOP that carry the data requested by the processor or an acknowledgment corresponding to a request. For Rd and RdMod requests, the responses are Fill and FillMod responses, respectively, each of which carries the requested data. For a CTD request, the response is a CTD-Success (Ack) or CTD-Failure (Nack) response, indicating success or failure of the CTD, whereas for a Victim request, the response is a Victim-Release response.

Unlike a computer network environment, the SMP system 100 is bounded in the sense that the processor and memory agents are interconnected by the HS 300 to provide a tightly-coupled, distributed shared memory, cache-coherent SMP system. In a typical network, cache blocks are not coherently maintained between source and destination processors. Yet, the data blocks residing in the cache of each processor of the SMP system are coherently maintained. Furthermore, the SMP system may be configured as a single cache-coherent address space or it may be partitioned into a plurality of hard partitions, wherein each hard partition is configured as a single, cache-coherent address space.

Moreover, routing of packets in the distributed, shared memory cache-coherent SMP system is performed across the HS 300 based on address spaces of the nodes in the system. That is, the memory address space of the SMP system 100 is divided among the memories of all QBB nodes 200 coupled to the HS. Accordingly, a mapping relation exists between an address location and a memory of a QBB node that enables proper routing of a packet over the HS 300. For example, assume a processor of QBB0 issues a memory reference command packet to an address located in the memory of another QBB node. Prior to issuing the packet, the processor determines which QBB node has the requested address location in its memory address space so that the reference can be properly routed over the HS. Mapping logic 250 is provided within the GP and directory of each QBB node that provides the necessary mapping relation needed to ensure proper routing over the HS 300.

In the illustrative embodiment, the logic circuits of each QBB node are preferably implemented as application specific integrated circuits (ASICs). For example, the local switch 210 comprises a quad switch address (QSA) ASIC and a plurality of quad switch data (QSD0-3) ASICs. The QSA receives command/address information (requests) from the processors, the GP and the IOP, and returns command/address information (control) to the processors and GP via 14-bit, unidirectional links 202. The QSD, on the other hand, transmits and receives data to and from the processors, the IOP and the memory modules via 72-bit, bi-directional links 204.

Each memory module includes a memory interface logic circuit comprising a memory port address (MPA) ASIC and a plurality of memory port data (MPD) ASICs. The ASICs are coupled to a plurality of arrays that preferably comprise synchronous dynamic random access memory (SDRAM) dual in-line memory modules (DIMMs). Specifically, each array comprises a group of four SDRAM DIMMs that are accessed by an independent set of interconnects. That is, there is a set of address and data lines that couple each array with the memory interface logic.

The IOP preferably comprises an I/O address (IOA) ASIC and a plurality of I/O data (IODO-1) ASICs that collectively provide an I/O port interface from the I/O subsystem to the QBB node. The IOP is connected to a plurality of local I/O risers (not shown) via I/O port connections 215, while the IOA is connected to an IOP controller of the QSA and the IODs are coupled to an IOP interface circuit of the QSD. In addition, the GP comprises a GP address (GPA) ASIC and a plurality of GP data (GPD0-1) ASICs. The GP is coupled to the QSD via unidirectional, clock forwarded GP links 206. The GP is further coupled to the HS via a set of unidirectional, clock forwarded address and data HS links 308.

A plurality of shared data structures is provided for capturing and maintaining status information corresponding to the states of data used by the nodes of the system. One of these structures is configured as a duplicate tag store (DTAG) that cooperates with the individual caches of the system to define the coherence protocol states of data in the QBB node. The other structure is configured as a directory (DIR) to administer the distributed shared memory environment including the other QBB nodes in the system. The protocol states of the DTAG and DIR are further managed by a coherency engine 220 of the QSA that interacts with these structures to maintain coherency of cache lines in the SMP system.

Although the DTAG and DIR store data for the entire system coherence protocol, the DTAG captures the state for the QBB node coherence protocol, while the DIR captures a coarse protocol state for the SMP system protocol. That is, the DTAG functions as a “short-cut” mechanism for commands (such as probes) at a “home” QBB node, while also operating as a refinement mechanism for the coarse state stored in the DIR at “target” nodes in the system. Each of these structures interfaces with the GP to provide coherent communication between the QBB nodes coupled to the HS.

The DTAG, DIR, coherency engine, IOP, GP and memory modules are interconnected by a logical bus, hereinafter referred to as an Arb bus 225. Memory and I/O references issued by the processors are routed by an arbiter 230 of the QSA over the Arb bus 225. The coherency engine and arbiter are preferably implemented as a plurality of hardware registers and combinational logic configured to produce sequential logic circuits and cooperating state machines. It should be noted, however, that other configurations of the coherency engine, arbiter and shared data structures may be advantageously used herein.

Specifically, the DTAG is a coherency store comprising a plurality of entries, each of which stores a cache block state of a corresponding entry of a cache associated with each processor of the QBB node. Whereas the DTAG maintains data coherency based on states of cache lines (data blocks) located on processors of the system, the DIR maintains coherency based on the states of memory blocks (data blocks) located in the main memory of the system. Thus, for each block of data in memory, there is a corresponding entry (or “directory word”) in the DIR that indicates the coherency status/state of that memory block in the system (e.g., where the memory block is located and the state of that memory block).

Cache coherency is a mechanism used to determine the location of a most current, up-to-date (dirty) copy of a data item within the SMP system. Common cache coherency policies include a “snoop-based” policy and a directory-based cache coherency policy. A snoop-based policy typically utilizes a data structure, such as the DTAG, for comparing a reference issued over the Arb bus with every entry of a cache associated with each processor in the system. A directory-based coherency system, however, utilizes a data structure such as the DIR.

Since the DIR comprises a directory word associated with each block of data in the memory, a disadvantage of the directory-based policy is that the size of the directory increases with the size of the memory. In the illustrative embodiment described herein, the modular SMP system has a total memory capacity of 256 GB of memory; this translates to each QBB node having a maximum memory capacity of 32 GB. For such a system, the DIR requires 500 million entries to accommodate the memory associated with each QBB node. Yet the cache associated with each processor comprises 4 MB of cache memory which translates to 64 K cache entries per processor or 256 K entries per QBB node.

Thus, it is apparent from a storage perspective that a DTAG-based coherency policy is more efficient than a DIR-based policy. However, the snooping foundation of the DTAG policy is not efficiently implemented in a modular system having a plurality of QBB nodes interconnected by an HS. Therefore, in the illustrative embodiment described herein, the cache coherency policy preferably assumes an abbreviated DIR approach that employs distributed DTAGs as short-cut and refinement mechanisms

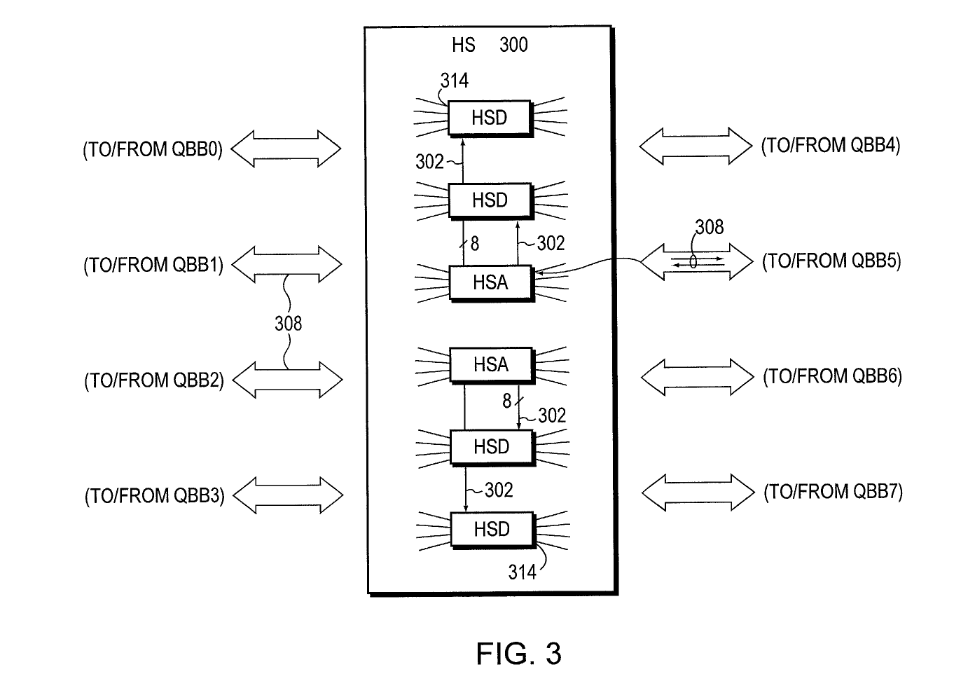

FIG. 3 is a schematic block diagram of the HS 300 comprising a plurality of HS address (HSA) ASICs and HS data (HSD) ASICs. In the illustrative embodiment, each HSA controls two (2) HSDs in accordance with a master/slave relationship by issuing commands over lines 302 that instruct the HSDs to perform certain functions. Each HSA and HSD includes eight (8) ports 314, each accommodating a pair of unidirectional interconnects; collectively, these interconnects comprise the HS links 308. There are sixteen command/address paths in/out of each HSA, along with sixteen data paths in/out of each HSD. However, there are only sixteen data paths in/out of the entire HS; therefore, each HSD preferably provides a bit-sliced portion of that entire data path and the HSDs operate in unison to transmit/receive data through the switch. To that end, the lines 302 transport eight (8) sets of command pairs, wherein each set comprises a command directed to four (4) output operations from the HS and a command directed to four (4) input operations to the HS.

The SMP system 100 maintains interprocessor communication through the use of at least one ordered channel of transactions and a hierarchy of ordering points. An ordered channel is defined as a uniquely buffered, interconnected and flow-controlled path through the system that is used to enforce an order of requests issued from and received by the QBB nodes in accordance with an ordering protocol. For the embodiment described herein, the ordered channel is also preferably a “virtual” channel. A virtual channel is defined as an independently flow-controlled channel of transaction packets that shares common physical interconnect link and/or buffering resources with other virtual channels of the system. The transactions are grouped by type and mapped to the various virtual channels to, among other things, avoid system deadlock. Rather than employing separate links for each type of transaction packet forwarded through the system, the virtual channels are used to segregate that traffic over a common set of physical links. Notably, the virtual channels comprise address/command paths and their associated data paths over the links.

In the illustrative embodiment, the SMP system maps the transaction packets into five (5) virtual channels that are preferably implemented through the use of queues. A QIO channel accommodates processor command packet requests for programmed input/output (PIO) read and write transactions, including CSR transactions, to I/O address space. A Q0 channel carries processor command packet requests for memory space read transactions, while a Q0Vic channel carries processor command packet requests for memory space write transactions. A Q1 channel accommodates command response and probe packets directed to ordered responses for QIO, Q0 and Q0Vic requests and, lastly, a Q2 channel carries command response packets directed to unordered responses for QIO, Q0 and Q0Vic request.

Each packet includes a type field identifying the type of packet and thus, the virtual channel over which the packet travels. For example, command packets travel over Q0 virtual channels, whereas command probe packets (such as FwdRds, Invals and SFills) travel over Q1 virtual channels and command response packets (such as Fills) travel along Q2 virtual channels. Each type of packet is allowed to propagate over only one virtual channel; however, a virtual channel (such as Q0) may accommodate various types of packets. Moreover, it is acceptable for a higher-level channel (e.g., Q2) to stop a lower-level channel (e.g., Q1) from issuing requests/probes when implementing flow control; however, it is unacceptable for a lower-level channel to stop a higher-level channel since that would create a deadlock situation.

The inventive technique described herein optimizes performance of the SMP system by taking advantage of certain properties of the system. As noted, the Q0 virtual channel carries a memory reference transaction issued by a processor to a memory. Lookup operations are performed in the directory and DTAG based on the address of the memory reference transaction to determine a coherency state of the requested data block. If the data block is “clean” and residing in the memory, then the response to the memory reference transaction is a Q1 fill command that includes the requested data; this response is transmitted over the Q1 virtual channel.

The Q1 fill command comprises two components: an ordered fill marker (Q1) component and an unordered fill (Q2) data component. If the result of the directory and DTAG lookup operations indicates that the requested data block is “dirty” and resident in a processor's cache, the home QBB node (i.e., the node including the memory) generates an ordered component that is forwarded to the cache. In response, the cache returns the requested data as a Q2 command over the Q2 virtual channel. Here, the ordered component forwarded to the processor's cache is a forwarded read command. In addition, a fill marker is returned to the requesting processor over the Q1 channel.

In the case of a short fill command type, system bandwidth is conserved because the packet comprises both an ordered component and a data component. Alternatively, separate packets may be issued for the ordered and data components; however those packets would consume additional system bandwidth. Thus, by combining the two components into a single, short fill packet, system bandwidth is conserved. A short fill command is generated when the result of the directory and DTAG lookup operations indicate that the memory on the home QBB node has the requested data and that requested data is “clean”, i.e., no other processor owns that data.

In most cases the memory has a clean copy of the requested data and, thus, combining of the ordered and data components into a single packet represents a substantial optimization in the system. However, there are situations where it may be advantageous to “split” the short fill command into its ordered and data components in order to increase performance of the SMP system. The present invention is directed to a technique for splitting a short fill command into its two components and, more generally, a technique for splitting a command response into its data component and ordered component to essentially transpose the command response into two discrete packets.

In the illustrative embodiment, the virtual channels of the SMP system are implemented over a common physical channel. Thus, if a response consumes two packets, it also consumes additional bandwidth on the physical channel. Although combining the two packets into a single packet may reduce the consumed bandwidth, there are situations where maintaining separate packets results in a performance improvement in the SMP system. For example, the Q1 virtual channel has an ordered property that maintains the ordering of packets over the virtual channel throughout the SMP system. However, the Q2 data channel and the Q0 request channel are both unordered virtual channels that do not maintain ordering of packets transmitted over those channels. A command response that includes both data and ordered components travels over the Q1 ordered channel because of the ordered component contained therein.

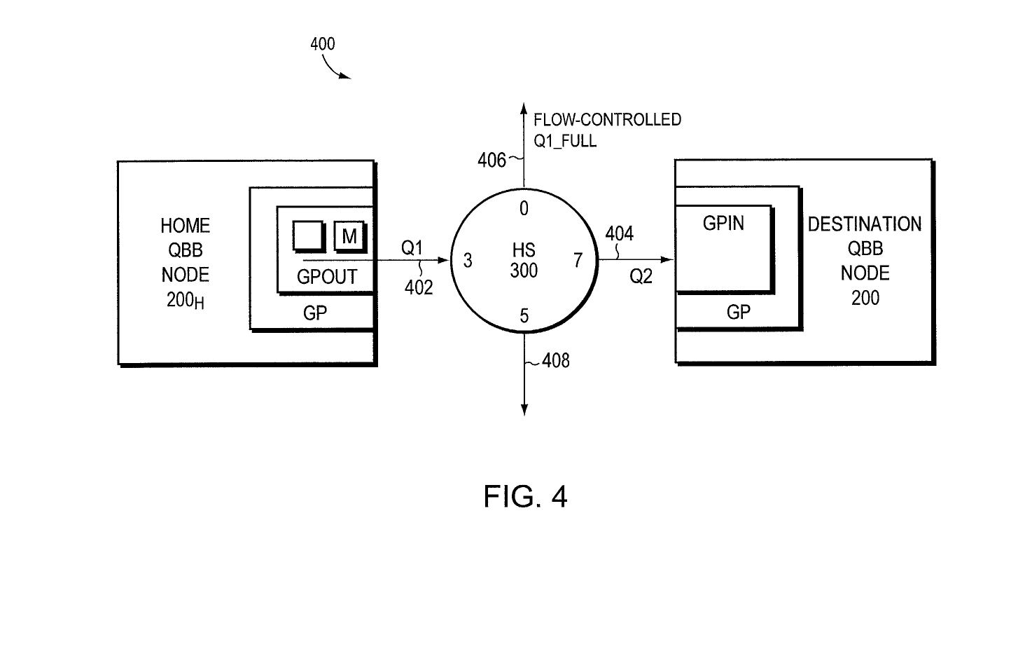

FIG. 4 is a schematic block diagram illustrating virtual channels 400 of the SMP system that may be advantageously used with the present invention. A physical channel 402 couples a GPOUT ASIC of a QBB node to the HS 300, and another physical channel 404 couples the HS to a GPIN ASIC of another QBB node. Other physical channels 406, 408 emanate from the HS. As noted, a plurality of virtual channels are implemented over the physical channels. Assume a command response packet is a combined packet that includes both ordered and data components. The combined command response packet travels over a Q1 virtual channel through the GPOUT ASIC of a home QBB node that includes the target memory of a memory reference operation issued by a processor.

Moreover, assume there is a stream of Q1 packets traveling over the Q1 virtual channel (extending over the physical channel 402) in an ordered arrangement. Furthermore, assume that the Q1 virtual channel at the home QBB node 200_{H} is stalled. The Q1 virtual channel may be stalled due to a series of probe packets (issued by a processor of the home QBB node) that are backing up in the Q1 virtual channel. Meanwhile, the Q2 virtual channel at the home QBB node 200_{H} is not stalled. Yet, since the combined packet travels over the Q1 channel, it cannot make progress until the probe packets make progress.

Alternatively, the Q1 virtual channel could be stalled because the Q1 packet at the “head” of the stream is a multicast packet (M) and one of its targeted ports in the HS is a full and flow controlled Q1 channel (e.g., port 0). Because the virtual channel at port 0 is stalled, the multicast packet stalls until the flow-controlled, Q1 channel “frees-up”. Meanwhile, the target destination of the data component of the combined command response packet is a Q2 channel (e.g., port 7) coupled to the GPIN ASIC of a destination QBB node. Notably, this Q2 virtual channel is not stalled. However, in a similar manner as described above, since the combined packet travels over the Q1 channel, it cannot make progress until the multicast packet makes progress.

According to the inventive technique, the GPOUT ASIC can “split” the combined packet into its ordered and unordered components, wherein the unordered component includes the data requested by a processor on the QBB node of the GPIN ASIC. By splitting the combined packet into its two components, the unordered data component can travel over the Q2 virtual channel through the HS and onto the GPIN ASIC in a manner that makes progress through the SMP system. Meanwhile, the ordered Q1 component of the combined packet maintains its place within the Q1 virtual channel so as to satisfy the ordering rules of the SMP system. The unordered data component of the combined packet can thus bypass the blocked Q1 channel and provide the data to the requesting processor in a fast and efficient manner that increases performance of the SMP system.

In the illustrative embodiment, the combined packet is a short fill command response packet that is apportioned into a Q1 fill marker packet and a Q2 long fill packet. Assume a processor on a QBB node requests a data block in accordance with a memory read operation. The memory read operation is directed to a memory on a home QBB node. At the home QBB node, directory and DTAG lookup operations indicate that the memory contains the requested data block. As a result, a short fill command response is generated that is directed to the requesting processor and issued over the Q1 command virtual channel. However at the GPOUT ASIC of the home QBB node, it is determined that the Q1 virtual channel is stalled. Accordingly, the short fill command response packet is divided into a Q1 fill marker packet that maintains the ordering in the Q1 virtual channel and a Q2 long fill packet that is transmitted over the Q2 virtual channel to the requesting processor. The Q2 long fill packet contains the data requested by the processor in connection with the memory read operation. Therefore, the data is returned to the processor in an efficient manner that increases the performance of the processor and the SMP system.

Broadly stated, decomposition logic in the GP of a QBB node decomposes the combined command response packet in response to detecting a non-flow controlled Q2 channel in the presence of a flow controlled Q1 channel. The decomposition logic essentially replicates the command response packet and changes the command type of the replicated packet to a long fill Q2 command packet that includes the requested data. The replicated packet is then forwarded over the Q2 channel to the requesting processor. Meanwhile, the decomposition logic changes the command type of the command response packet within the Q1 channel to a fill marker and maintains that Q1 command within the Q1 virtual channel.

The decomposition logic is located primarily within the GPA ASIC of each GP within a QBB node, although the data component of a combined packet is handled by the GPD ASIC of the GP. Although splitting a combined packet into two discrete packets consumes more bandwidth over the system interconnect, the inventive technique actually increases performance in a situation where the ordered channel is stalled and the unordered Q2 channel is available. Previous systems may be configured to always issue the data and ordered components as separate packets; yet, this type of configuration is generally inefficient because it always consumes more bandwidth than the illustrative embodiment wherein a combined packet is often used to respond to a memory reference request.

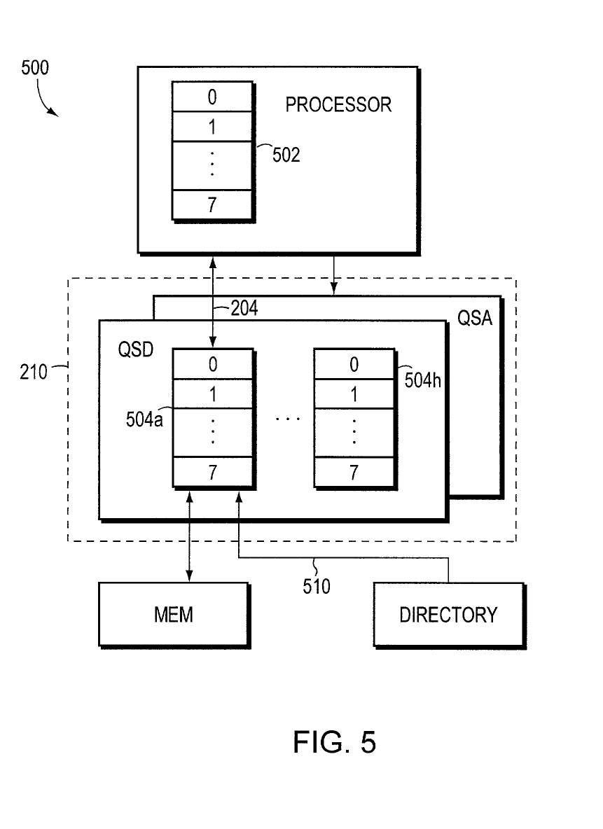

FIG. 5 is a schematic block diagram showing an arrangement 500 between a processor and the QSA/QSD ASICs of a local switch within a QBB node. Each processor includes an output buffer 502 that can accommodate a plurality of, e.g., up to eight (8), outstanding references. These references are issued to the local switch 210 and stored in buffers of the QSA and QSD ASICs. Specifically, the QSD includes eight (8) data buffers 504a-h, each adapted to accommodate up to eight (8) outstanding memory reference operations issued by the processor to the memory.

Assume the processor issues a reference operation to the memory for a particular data block that is “dirty” in a processor's cache on another QBB node. Rather than waiting for the directory's response indicating that the desired memory block is dirty, the memory proceeds to satisfy the request with a fill response including invalid data from the memory. This invalid data is loaded into a data buffer 504a of the QSD and, simultaneously, a signal from the directory is provided along with the data specifying that the data is invalid since it is dirty on another QBB node. Thus, the directory issues a signal 510 that desserts the data valid signal accompanying a requested data block so that the requesting processor knows that the data block is invalid and that a valid data block will subsequently be returned.

Assume further that a clock forwarded link 204 between the QSD and processor is busy handling, e.g. victim and probe read traffic from the processor to the QSD, such that the data buffer 502 becomes full with similar invalid data destined to the processor. In this situation, there is no room in the data buffers for the valid data provided to the QSD as a result of e.g., forwarded read Q2 commands issued by the processors having the dirty copies of the data blocks. This situation is analogous to the IOP that can issue up to sixteen reference operations to the system because it has an output buffer that can accommodate up to sixteen outstanding references. Although the IOP can issue up to sixteen references to the SMP system, the local switch 210 only provides four data buffers for returning data. Thus, for a given processor (either the processor or IOP) there may be more data blocks returned to the QSD as a result of outstanding reference operations issued by the processors than there are data buffers available in the QSD to accommodate those returned data blocks. Notably, there are buffers in the QSA corresponding to the data buffers in the QSD. Accordingly, a general problem addressed by the present invention involves a situation where there is less buffering available in the system than there are potential outstanding references.

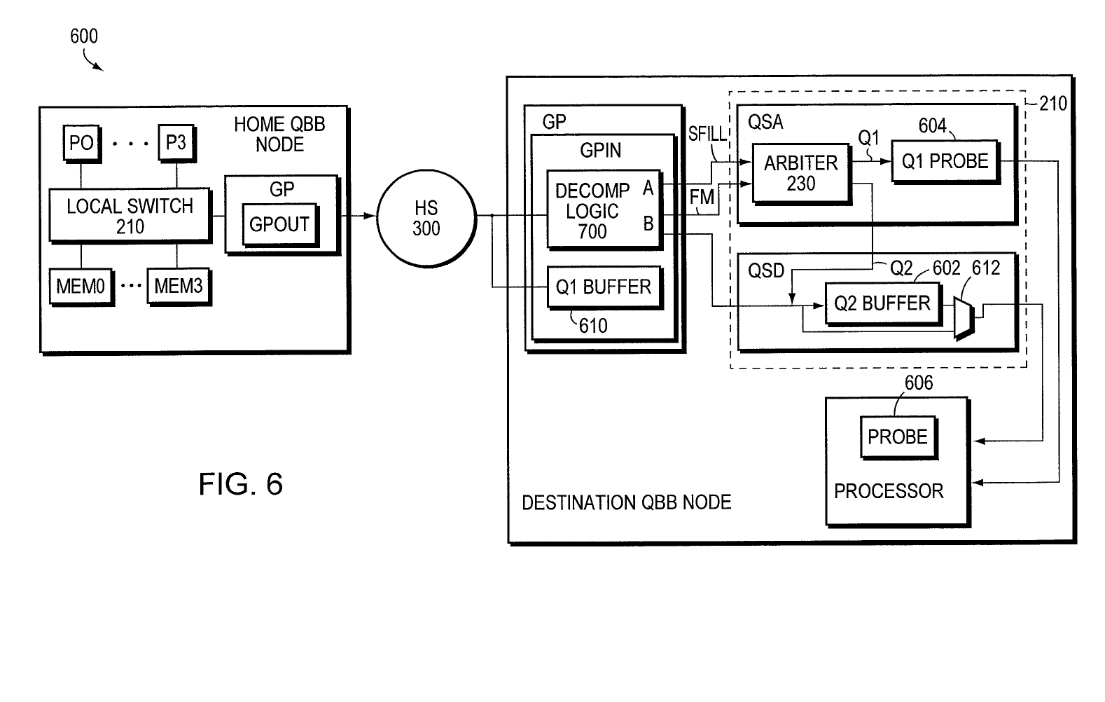

FIG. 6 is a schematic block diagram illustrating an arrangement 600 between a home QBB node and a destination QBB node that may be advantageously used with the present invention. Within the QSD, there is a buffer 602, preferably of fixed size, for storing Q2 commands destined for a processor, such as a processor or IOP. In addition, there is a Q1 probe queue 604 within the QSA that accommodates Q1 commands, such as probes, transported over a Q1 channel to the processor. The processor may further include a probe queue 606 for storing Q1 packets.

A simple solution to the buffer availability problem is to have each Q0 command directed to a memory manifest as two components (Q1 and Q2 components), each of which is independently flow controlled across the SMP system. However, a Q1 fill marker and a Q2 long fill consume the same amount of address bandwidth, while the Q2 long fill consumes additional data bandwidth. Accordingly, transmission of independent Q1 and Q2 components consumes twice as much address bandwidth as the bandwidth consumed by one combined packet (a short fill packet). In order to preserve bandwidth on the SMP system interconnects, it is desirable to transport combined command response packets, such as short fills, whenever possible.

Once the Q0 command is received at the memory of the home QBB node, a short fill packet is generated in response to the Q0 command (whenever possible). The generated packet is transmitted through GPOUT of the home QBB node across the HS 300 and through GPIN of the source QBB node where the requesting processor resides. At that point, the short fill command response is received at the arbiter 230 of the QSA and apportioned into its two components (Q1 fill marker and Q2 long fill) each of which is issued over the Arb bus and onto their respective virtual channels to the requesting processor. Notably, the short fill travels throughout the SMP system “pushing” probes in front of it in accordance with the ordering rules of the system.

Once the short fill is broken into its Q1 and Q2 components, the Q1 fill marker component continues to push probes through the Q1 probe queue 604 of the QSA while maintaining ordering in accordance with the ordering rules. On the other hand, the Q2 long fill component travels over a Q2 virtual path that may include the Q2 buffer 602 within the QSD. However, if the processor is able to immediately receive the long fill data, there may be a bypass function over which the Q2 data may proceed without being stored in the buffer. The bypass function is preferably implemented as a multiplexer 612 and resides within a processor interface circuit of the QSD. Thus, if probes are pending in the Q1 probe queue 604, the Q1 fill marker proceeds more slowly to the processor than the Q2 long fill data.

Assume now that the Q2 buffer 602 on the Q2 virtual channel is full and that there is no bypass path around the buffer. A short fill packet traversing the HS 300 must stop prior to the arbitration function in the QSA because there is no room for its data component within the Q2 buffer of the QSD. Essentially, the short fill packet is loaded into a Q1 buffer 610 within the GPIN and, if a plurality of short fill packets are issued during the time that the Q2 buffer is full, the Q1 buffer 610 begins to back up. This situation is highly undesirable because, in the SMP system, the Q1 ordered channel is a critical element of the system that must make progress in order to maintain performance of the system. Since the Q1 channel is an ordered channel, if that channel backs up then all other ordered components of the system back up, thereby impeding performance of the system.

Therefore, a problem arises when the Q2 buffer 602 within the QSD is full and there are additional short fill packets entering the local switch 210. This case is particularly applicable to the IOP, which may have more outstanding short fill packets than buffers available in the QSD. In that case, the short fill packets may be stalled within the Q1 buffer 610 ofthe GPIN. A tradeoff then arises between (1) optimizing bandwidth at the HS by creating the short fill packets that may potentially impede progress of the Q1 components of the short fill at the QSA and (2) issuing discrete Q1 and Q2 packets at the home QBB node (and thereby eliminate the short fill packet) and thus sacrificing bandwidth throughout the SMP system. The present invention addresses this situation by providing a technique that essentially eliminates the need for such a tradeoff.

According to the invention, the technique acknowledges that the short fill packet comprises two components, a Q1 fill marker and a Q2 long fill, that can be combined and separated any number of times along the path throughout the SMP system to the source QBB node. Therefore, the Q1 and Q2 components are combined at the GPOUT of the home QBB node to form a short fill packet that is forwarded over the HS to the GPIN of the source QBB node. At the GPIN, the decomposition logic 700 has a single input and two outputs that feed the arbitration function of the QSA. When the short fill packet is received at the input of the logic 700, a decision is made based on whether the Q2 buffer 602 is full and/or whether the Q1 probe queue 604 is full.

Specifically, the short fill packet is received at GPIN and loaded into the Q1 buffer (queue) 610. The decomposition logic, which preferably comprises a combination logic function, is invoked once the packet makes it way to the head of the queue 610. If there are available entries of the Q1 probe queue 604 (i.e., there is space available in the Q1 queue) but there is no available space in the Q2 buffer 602 for the Q2 component of the short fill (i.e., the Q2 buffer is full), then output B of the logic 700 is selected. As a result, the short fill packet is decomposed into a Q1 fill marker component and a Q2 long fill component. The arbiter 230 sends the Q1 fill marker (FM) component over the Q1 virtual channel and into the Q1 probe queue 604 as the Q2 component waits until there is available space in the Q2 buffer 602. This allows the Q1 ordered channel to progress despite the Q2 virtual channel being stalled.

On the other hand, if neither the Q1 probe queue 604 nor the Q2 buffer 602 is full, than output A of the logic 700 is selected. The short fill packet propagates on as a short fill (SFILL) until it reaches the arbitration function where the arbiter 230 apportions that combined packet into its Q1 and Q2 components, and forwards them over their respective virtual channels to the processor. Note that there are counters located within GPIN that are used to determine when the Q2 buffer is full. This arrangement may also apply to the Q1 probe queue.

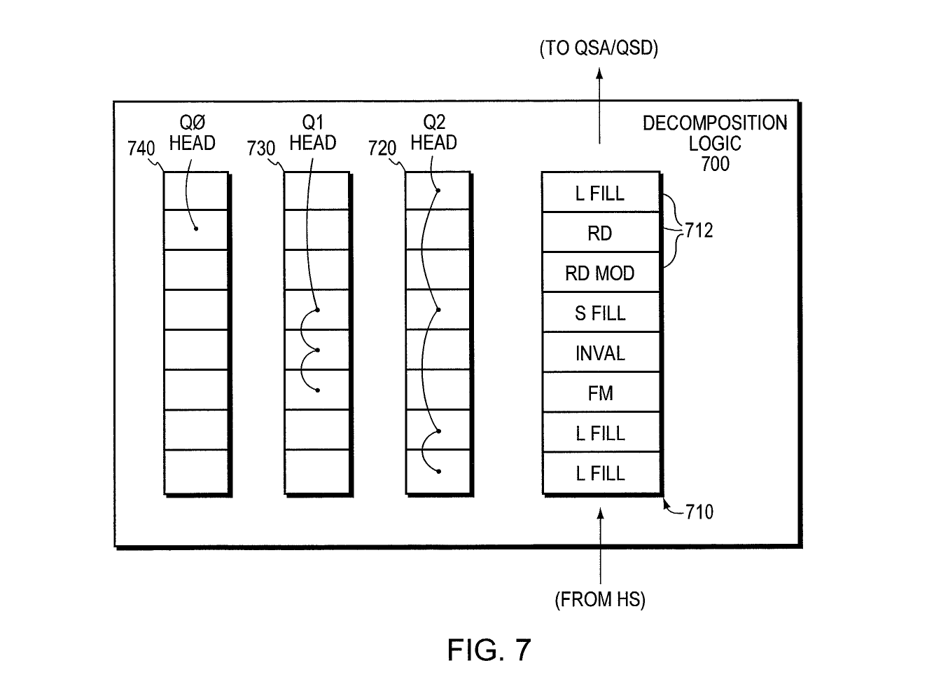

In the illustrative embodiment, the combinatorial logic function of the decomposition logic 700 used to perform decomposition of the short fill packet into its Q1 and Q2 components basically comprises a linked list mechanism that is also used in the HS. FIG. 7 is a schematic block diagram of the decomposition logic 700 comprising a table 710 having a plurality of entries 712 (e.g., 8 entries), each configured to accommodate a packet of any type. When a reference is received at GPIN, it is loaded into an entry of this table. The logic 700 also comprises a plurality of linked lists each associated with a particular virtual channel such as a Q0 740, Q1 list 730 and Q2 list 720. These linked lists, which include head pointers and tail pointers, are created when the packets are received at the decomposition logic.

As Q2 commands are received at the logic 700 and loaded into entries of the table, the Q2 tail pointer (not shown) “stitches” these commands into a chain defined by the Q2 head pointer. Similarly, the Q1 tail pointer stitches in Q1 commands that were loaded into the table entries within a chain defined by the Q1 head pointer. For example, a short fill (SFILL) packet is preferably stitched into both the Q1 and the Q2 chains. When the short fill reaches the head of the Q1 queue in the GPIN, the combinatorial logic decides whether to leave the short fill packet in the Q2 chain. If there is no room for the Q2 component in the Q2 buffer, the Q1 component of the short fill packet is sent along while the Q2 component is stitched into the end of the Q2 chain.

In summary, the present invention comprises a technique that efficiently combines data and ordered transactions in a multiprocessor system having a plurality of nodes interconnected by a hierarchical switch. The technique further enables an ordered channel of the system to make progress in the presence of a blocked interface within the hierarchical switch. Specifically, the inventive technique combines ordered components and unordered data components into common packets that are transmitted over an ordered channel of the system in the event the ordered and unordered components are generated simultaneously. In the event that a combined packet in the ordered channel is stalled due to a data buffer dependency, the technique further allows decomposition of the packet into an ordered component and an unordered data component. In this latter case, the ordered component remains in the ordered channel and the unordered data component is reassigned to the unordered data channel.

The foregoing description has been directed to specific embodiments of the present invention. It will be apparent, however, that other variations and modifications may be made to the described embodiments, with the attainment of some or all of their advantages. Therefore, it is the object of the appended claims to cover all such variations and modifications as come within the true spirit and scope of the invention.

What is claimed is:

1. A method for efficiently transmitting packets within a multiprocessor computer system having a plurality of multiprocessor nodes interconnected by a switch fabric, the system having one or more ordered virtual channels and one or more unordered virtual channels configured to carry request and response packets among the multiprocessor nodes, the method comprising the steps of:
providing at a first node at least one ordered queue for storing packets subject to an ordering requirement in the multiprocessor computer system;
providing at the first node at least one unordered buffer for storing packets which are not subject to an ordering requirement;
receiving at the first node a single, common packet that includes both an ordered component and an unordered component;
determining whether available space exists at the ordered queue and at the unordered buffer;
if available space exists at the ordered queue, but not at the unordered buffer, decomposing the single, common packet into a separate ordered component and a separate unordered component; and
placing the separate ordered component that was decomposed from the single, common packet into the ordered queue, thereby allowing the ordered virtual channel to progress.

2. The method of claim 1 further comprising the step of holding the unordered component that was decomposed from the single, common packet until there is available space at the unordered buffer.

3. The method of claim 2 further comprising the steps of:
providing an ordered linked list;
providing an unordered linked list;
in response to receiving the single, common packet, adding the ordered component to the ordered linked list and the unordered component to the unordered linked list; and
if available space exists at the ordered queue, but not at the unordered buffer, the step of decomposing comprises the steps of:
removing the ordered component from the ordered linked list; and
moving the unordered component to a tail of the unordered linked list.

4. The method of claim 3 further comprising the steps of:
providing a table having a plurality of entries configured to store packets received at the first node;
storing the single, common packet that includes both the ordered component and the unordered component at the table;

5. The method of claim 4 wherein the single, common packet is formed when the ordered and unordered components are generated substantially simultaneously.

6. The method of claim 5 wherein the single, combined packet is a short fill that includes an ordered fill marker command component and an unordered long fill data component.

7. A method for efficiently transmitting packets within a multiprocessor computer system having a plurality of multiprocessor nodes interconnected by a switch fabric, the system having one or more ordered virtual channels and one or more unordered virtual channels configured to carry request and response packets among the multiprocessor nodes, the method comprising the steps of:
combining an ordered response component with an unordered response component to form a single, combined response packet;
placing the single, combined response packet into an ordered virtual channel for transmission to a requesting processor;
detecting a stall condition at the ordered virtual channel into which the single, combined response packet was placed;
in response to detecting the stall condition, decomposing the single, combined response packet back into a separate ordered response component and a separate unordered response component; and
placing the decomposed unordered response component into an unordered virtual channel for transmission to the requesting processor, thereby permitting the unordered component to progress through the system despite the stall condition at the ordered virtual channel.

8. The method of claim 7 wherein the command response component remains in the ordered virtual channel.

9. The method of claim 8 wherein the decomposing and placing steps occur provided that the unordered virtual channel is available.

10. The method of claim 8 further comprising the steps of:
receiving a memory reference operation at a first node of the multiprocessor system, the memory reference operation issued by the requesting processor and specifying requested data;
generating a command response component in response to the memory reference operation; and
generating a fill data component in response to the memory reference operation, the fill data component including the requested data, wherein
the command response component corresponds to the ordered response component, and
the fill data component corresponds to the unordered response component.

11. The method of claim 10 wherein the single, combined transaction has a command type, the method further comprising the step of setting the command type of the single, combined transaction such that it is recognized by the multiprocessor system as a short fill command response.

12. The method of claim 11 wherein the step of decomposing comprises the steps of:
replicating the short fill command response;
changing the command type of the replicated short fill command response such that it is recognized by the multiprocessor system as a long fill command response.

13. The method of claim 12 further comprising the step of changing the command type of the single, combined transaction remaining in the ordered virtual channel such that it is recognized by the multiprocessor system as a fill marker response.

14. The method of claim 13 wherein the virtual channels include:
a QIO channel configured to accommodate processor command packet requests for programmed input/output (I/O) read and write transactions;
a Q0 channel configured to accommodate processor command packet requests for memory read transactions;
a Q0Vic channel configured to accommodate processor command packet requests for memory write transactions;
a Q1 channel configured to accommodate command response packets directed to ordered responses for QIO, Q0 and Q0Vic requests; and
a Q2 channel configured to accommodate response packets directed to unordered responses for QIO, Q0 and Q0Vic requests.

15. The method of claim 14 wherein the ordered virtual channel into which the single, combined transaction is placed is the Q1 virtual channel.

16. The method of claim 15 wherein unordered virtual channel into which the decomposed fill data component is placed is the Q2 virtual channel.

17. The method of claim 16 wherein decomposed long fill data component is transmitted over the Q2 virtual channel while the short fill command response component remains in the stalled Q1 virtual channel.
